(19) United States
(12) Patent Application Publication
(10) Pub. No.: US 2026/0253248 A1
(43) Pub. Date: Aug. 27, 2026

(54) METHOD FOR DETERMINING THE POSITION OF A SPOTLIGHT AND CALIBRATING SAME

(71) Applicant: zactrack GmbH, Wien (AT)

(72) Inventor: Werner PETRICEK, Kierling (AT)

(73) Assignee: zactrack GmbH, Wien (AT)

(21) Appl. No.: 18/870,702

(22) PCT Filed: May 24, 2023
(86) PCT No.: PCT/AT2023/060168

§ 371 Date: Dec. 2, 2024

(30) Foreign Application Priority Data
Jun. 1, 2022 (AT) A50387/2022

(51) Int. Cl. G06T 7/73; G06T 7/13; G06T 7/62; H04N 13/239

(52) U.S. Cl. CPC G06T 7/73; G06T 7/13; G06T 7/62; H04N 13/239; F21W 2131/406; G06T 2207/10012

(57) ABSTRACT

A method for determining the position of a spotlight (1) which is arranged above an underlying surface (3) and creates an illuminated region (5) on the underlying surface (3), wherein a light sensor (2) is arranged on the underlying surface (3), wherein the light sensor (2) is designed as a camera, wherein the camera comprises a wide-angle lens, preferably a fisheye lens, and wherein the light sensor (2) comprises one to three position sensors, preferably ultra-wideband position sensors (8), which are designed to determine the position of the light sensor (2) in a three-dimensional coordinate system, wherein the camera creates a recording of the spotlight (1), and wherein the position of the spotlight (1) is at least approximately determined from the recording and the position of the light sensor (2).

The invention relates to a method for determining the position and calibrating a spotlight.

In particular, spotlights for illuminating stages in theatre and event technology, but also for other applications, such as sporting events, for example, are known, which are arranged above an underlying surface and create an illuminated, preferably elliptical area on the underlying surface via a cone of light.

In particular, so-called moving head or head-mounted spotlights are known, which are rotatably/pivotably arranged along two axes. The two axes are a pivot axis extending parallel to the underlying surface, usually referred to as tilt axis, and a rotational axis extending normal to the underlying surface, usually referred to as pan axis. The spotlight is generally rotatable by up to 540° along the pan axis and generally pivotable by up to 270° along the tilt axis. With this type of spotlight, preferably any point on the underlying surface can be illuminated by adjusting the pan and tilt values.

In order to set up spotlights for computer-aided and preferably automatic illumination of people on the underlying surface, the spotlights must be calibrated with regard to their position and their control values.

In particular, the position of the spotlight must be known in absolute coordinates. In addition, for head-mounted spotlights, it must be known which control values of the used protocol lead to the desired rotation of the spotlight, wherein the pan and tilt values of the spotlight must be mapped to the DMX protocol used most commonly. In practice, however, several problems arise during calibration.

First, the point in three-dimensional space at which the spotlight is located must be determined (x, y and z coordinates). This is usually done by mapping the stage space and the position of the spotlights, as well as by computer-aided generation of a three-dimensional model. This is cumbersome and error-prone-in most cases it is not possible to measure the exact position of the spotlight correctly. There is also a risk of an intentional or unintentional change of the position of the spotlight between the time of the measurement and the time of the performance.

Further, with head-mounted spotlights, the relation between the pan and tilt values used to control the spotlight and the resulting changes in the light beam on the stage must be determined. In other words, the pan and tilt values required to achieve a certain displacement of the light beam on the stage must be determined. This mapping rule is also usually created using the computer-generated 3D model; hence, the same inaccuracies may occur. A reliable assignment of the computer-generated model to the real conditions in the stage space is not possible.

Finally, a clear localisation of the spotlight also requires the determination of the rotation, i.e. the beam direction of the light beam created by the spotlight. Here, too, the problem arises that the computer-generated model generally does not correspond to the actual conditions.

According to the invention, these and other problems are solved by providing a method according to the characterising features of claim 1.

In a method according to the invention, a spotlight is arranged above a underlying surface, where it creates an illuminated area. According to the invention, the spotlight may be any lighting fixture. The spotlight may be permanently installed. However, it may also be provided that the spotlight is rotatable about a pan axis by entering pan values and pivotable about a tilt axis by entering tilt values.

A light sensor is arranged on the underlying surface. According to the invention, the light sensor is designed as a camera that has a wide-angle lens, preferably a fisheye lens. The camera preferably has an angle of view of more than 100°, preferably more than 140°, particularly preferably about 180°. The camera may be a conventional 2D camera or a stereo camera.

The light sensor comprises one to three position sensors, preferably ultra-wideband position sensors, which are designed to determine the position of the light sensor in a three-dimensional coordinate system. The camera and the position sensors may be wirelessly connected to a data processing unit. The spotlight may also be connected to the data processing unit.

In a method according to the invention, the camera records a recording, i.e. a photo or video, of the spotlight, and a data processing unit calculates the position of the spotlight, at least approximately, based on the recording and the position of the light sensor.

In a moving spotlight, it may be provided that the spotlight is rotated and pivoted by entering tilt and pan values until a pan and tilt value is reached at which the camera detects the spotlight. Preferably, the camera may clearly detect a light emission point of the spotlight at this position in order to be able to determine an exact position of the centre point of the spotlight. Subsequently, the position of the spotlight in the coordinate system is calculated at least approximately based on the recording of the camera and the location of the camera determined by the position sensors.

For example, a two-dimensional position of the spotlight may be determined based on the recording of a 2D camera, and then the three-dimensional position of the spotlight in the coordinate system may be estimated from the estimated height of the spotlight above the underlying surface.

According to the invention, it may further be provided that the light sensor is arranged at at least two different positions on the underlying surface. Optionally, if the spotlight is movable, the spotlight may then be rotated and pivoted for both positions by entering tilt and pan values until a pan and tilt value is reached at which the camera detects the spotlight. The camera creates a recording of the spotlight at each of the two positions. The position of the spotlight in the three-dimensional coordinate system is then calculated based on the two recordings and the measured positions of the camera. Conventional algorithms for superimposing two recordings of a fixed point taken at different but known positions may be used to calculate the position (photogrammetry).

According to the invention, it may further be provided that the light sensor is designed as a stereo camera with two separate and spaced-apart individual cameras, wherein the cameras each have a wide-angle lens, preferably a fisheye lens. The individual cameras are arranged at a known distance from each other, for example 10 cm to 20 cm. The cameras may have an angle of view of more than 100°, preferably more than 140°, particularly preferably about 180°. The data processing unit knows the distance between the individual cameras.

If the spotlight is a moving spotlight, it is rotated and pivoted by entering tilt and pan values until a pan and tilt value is reached at which both cameras detect the spotlight. As a stereo camera is used, both cameras may simultaneously create a recording of the spotlight. In practice, it is often sufficient for the spotlight to flash at the light sensor, as both cameras may usually record the spotlight due to the wide aperture angle of the cameras. As a result, the position can be determined very quickly and without having to move the light sensor.

Subsequently, the position of the spotlight in the coordinate system is then calculated based on the different recordings of the two cameras, the known distance between the cameras and the position of the light sensor in the coordinate system, wherein conventional algorithms are again used for superimposing two recordings of a fixed point created at different but known positions (photogrammetry).

According to the invention, when using a movable spotlight, it may be provided that a mapping rule of the spotlight is determined by moving the illuminated area over the underlying surface by rotating and pivoting the spotlight until at least one of the cameras detects the edges of the illuminated area. This is possible both in the version with only one 2D camera and in the version with a stereo camera.

Subsequently, a mapping rule of the pan values and/or tilt values of the spotlight to the angular coordinates of the spotlight is determined by rotating and/or pivoting the spotlight and by repeatedly detecting the illuminated area. In particular, a method as described in WO 2018/154108 A1 may be used to calculate the mapping rule.

It may be provided, that the illuminated area is moved across the underlying surface by rotating and pivoting the spotlight until at least one of the two cameras detects an edge of the illuminated area and that, subsequently, the dimensions as well as a centre of the illuminated area are determined by varying the pan value and/or the tilt value of the spotlight.

According to the invention, it may be provided that the dimensions of the illuminated area are detected and that the aperture angle of the cone of light is determined from the calculated mapping rule. It may in particular be presupposed that the cone of light is symmetrical so that the aperture angle is identical in the pan axis and the tilt axis.

According to the invention, it may be provided that first, a mapping rule of the pan values to absolute angular coordinates and the aperture angle of the cone of light along this plane are determined by measuring the illuminated area along the plane spanned by the pan values.

Subsequently, a mapping rule of the tilt values to absolute angular coordinates may be determined by measuring the illuminated area along the plane spanned by the tilt values.

According to the invention, in the embodiment with a stereo camera, it may be provided that the mapping rule and/or the aperture angle is/are determined for each of the two cameras of the light sensor. The determined mapping rules may then be compared and optionally, if deviations occur, an error signal may be output. It may also be provided that the mean value of the mapping rules determined by the two cameras is defined to determine an average mapping rule.

According to the invention, it may be provided that the method is applied to several spotlights in sequential order.

The invention further relates to a computer-readable storage medium, comprising a computer programme, for example a smartphone app or a programme on a server, which controls the progress of the method according to the invention. The computer programme may control the spotlight with the necessary pan and tilt values, receive the camera images and calculate the target values of the method.

The spotlight may work in any wave length range, wherein the cameras are configured to detect the signals sent by the spotlight. In particular, a wave length range of 380 nm to 780 nm (visible light) or higher (infrared) may be provided.

Further features according to the invention emerge from the claims, the description of the embodiments and the figures.

In the following, the invention is explained in more detail on the basis of a non-exclusive exemplary embodiment.

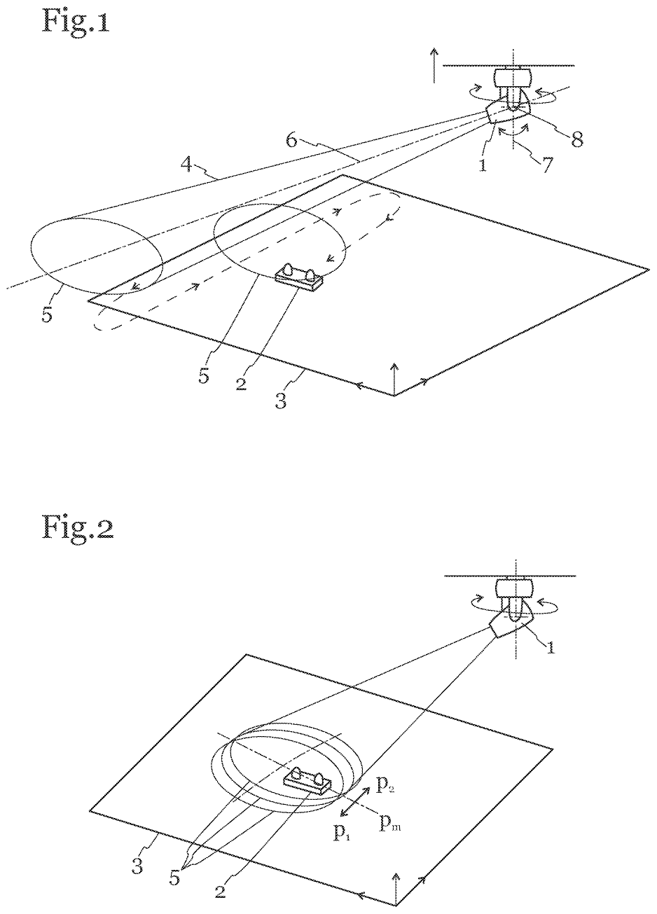

FIGS. 1 to 7 show consecutive method steps of an embodiment of the method according to the invention on the basis of a spotlight and a light sensor 2 arranged on the underlying surface. In this embodiment, the light sensor is designed as a stereo camera comprising two individual cameras arranged at a distance of about 15 cm, each equipped with a fisheye lens with an angle of view of about 150°.

FIG. 1 shows an underlying surface 3, for example a theatre stage, and a spotlight 1 mounted above the underlying surface. A mobile light sensor 2 in the form of a stereo camera having two (schematically depicted) fisheye lenses is arranged on the underlying surface 3. The light sensor 2 can be controlled wirelessly and is connected to an external computer unit. The light sensor is not fixed to the underlying surface 3, but is placed removably on the underlying surface.

Further, there are two ultra-wideband position sensors (not depicted) on the light sensor 2, which may be used to determine the absolute position of the mobile light sensor 2 in a three-dimensional coordinate system.

The spotlight 1 is pivotable about two axes that are normal to each other. The spotlight is rotatable by about 540° along the schematically indicated pan axis 7. The spotlight is pivotable by 180° along the schematically indicated tilt axis 8. The spotlight 1 emits a cone of light 4 with a cone of light axis 6, creating an illuminated area 5 on the underlying surface 3. The illuminated area 5 created on the underlying surface 3 is usually elliptical.

By rotating about the pan and tilt axis, the spotlight 1 can illuminate any point on the underlying surface 3. In the considered embodiment, the possible value range for the pan and tilt values is 0 to 2¹⁶=65536 ticks. Hence, from the pan value 0 to the pan value 65536, the spotlight rotates about the pan axis by about 540°. It can be assumed that the mapping of the pan values to the angular range is linear, but the exact mapping rule of the pan values to the angular range covered is unknown. The same applies to the tilt values.

In an embodiment of the invention, first the light sensor 2 is placed on the underlying surface 3 and then the cone of light 4 is systematically moved along a pre-defined curve across the underlying surface 3 until a camera of the light sensor 2 detects the edge of the illuminated area 5. In FIG. 1, the curve along which the cone of light 4 is moved is schematically indicated as a dashed line. As soon as both cameras of the stereo camera detect the illuminated area 5, the movement of the spotlight 1 stops and the pan value p1 and tilt value t1 of this position are saved.

To determine the position of the spotlight 1, the two cameras of the light sensor 2 each record a photo of the spotlight 1. Based on the two photos, the distance between the cameras and the known position, the position of the spotlight 1 in the coordinate system is determined by photogrammetry.

In an exemplary embodiment of the invention which is not depicted, the position is determined by a mobile light sensor with only one 2D camera, wherein, however, the position of the light sensor must be changed after the first recording.

FIG. 2 shows the next step of the method according to the invention for determining a mapping rule. In this step, starting from the edge of the illuminated area 5 detected by initially one of the cameras, the spotlight 1 is moved further at an unchanged tilt value 7 in the pan axis, in order to detect the end of the illuminated area 5, i. e. a decrease of the received light intensity to below a threshold value. Once this is detected, the movement of the spotlight stops and the pan value p2 is saved. The centre in the direction of the pan axis pm is determined from pm=(p1+p2)/2 and the spotlight moves in this position. In an exemplary embodiment of the method the pan values p1=30624 and p2=33184 are detected as edges of the illuminated area so that the centre in the direction of the pan axis pm is calculated as being 31904.

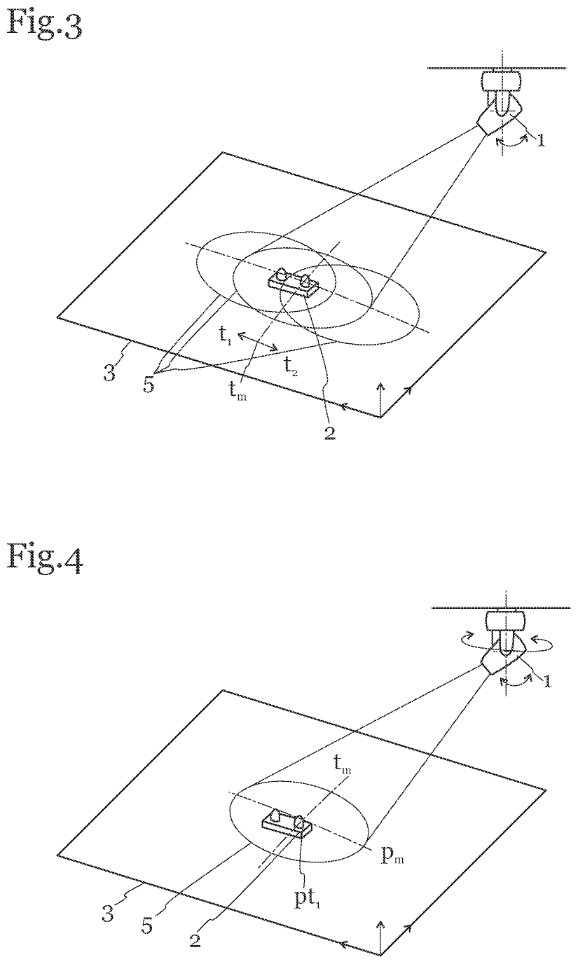

FIG. 3 shows the next step of this embodiment. In this step, the spotlight is moved back and forth along the tilt axis at a fixed pan value pm, until the two edges of the illuminated area are detected. The respective tilt values along the pan value pm are saved as t1 and t2 and the mean value tm is calculated as tm=(t1+t2)/2. The centre of the illuminated area 5 is set in pan values and tilt values by the tupel of the two calculated mean values pt1=(pm, tm).

In FIG. 4 the spotlight 1 is controlled with the values of the tupel pt1 so that the centre of the illuminated area 5 moves to the exact position of the light sensor 2.

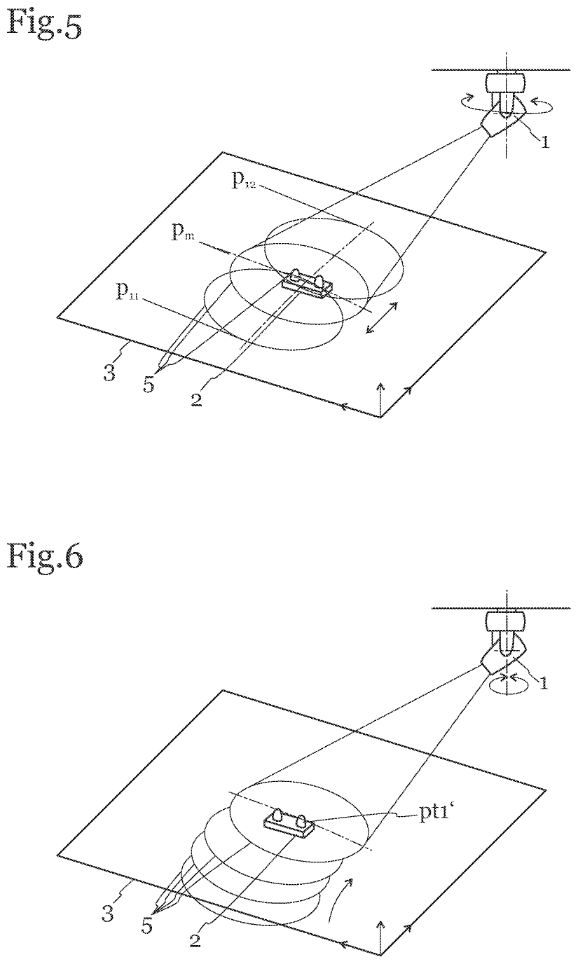

In FIG. 5, in a next step of the method, the pan expansion of the illuminated area 5 is determined in its centre.

To this end, the spotlight 1 is moved back and forth in its pan axis at a fixed tilt value tm, and the edges of the illuminated area 5 are detected. This provides the outer delimiting pan values p11 and p12 of the illuminated area 5.

In FIG. 6, the spotlight performs a complete rotation by 360° in the pan axis until the illuminated area meets the light sensor 2 again.

In case the spotlight at point pt1 has been rotated about the pan axis so far that a further rotation by 360° about the pan axis is no longer possible, the spotlight may perform a rotation by 180° about the pan axis and a tilt flip, i. e. a mirroring of the tilt value about the vertical axis of the spotlight. This means that at a tilt value of t1=Y the new tilt value is set to 65536-Y. However, the tilt value calculated in this manner is only correct if the tilt values are distributed symmetrically around the middle axis of the spotlight. If this is not the case, the tilt flip may lead to an incorrect tilt value. Thus, an embodiment of the invention provides that the new tilt value after the tilt flip is not set to 65536-Y, but that the limits of the illuminated area are determined anew by pivoting the spotlight back and forth along the tilt axis at a fixed pan value, and that the new tilt value tm′ is calculated based on them.

Then, by increasing the pan value, the outer delimiting pan values p21 and p22 are measured anew and the average pm is calculated as pm′=(p21+p22)/2. The centre of the illuminated area 5 is set in pan values and tilt values by the tupel pt1′=(pm′, tm′).

When detecting the illuminated area anew, the values p21=52504 and p22=55064 are, for example, determined so that the point pm′ takes on the value 53784. Hence, it is known that the spotlight has performed a rotation by a certain angle between the first detected pan value 33184 and the second detected pan value 55064, namely either 360° without tilt flip or 180° if a tilt flip was necessary.

Now, from the difference of the points pt1 and pt1′ a mapping rule of the pan values to the absolute angular coordinates can be determined. In case the spotlight only performed a rotation by 180° and a tilt flip, the difference of the pan values has to be mapped to a rotation by 180°.

From the two limits of the illuminated area 5 and the mapping rule between the pan values and the absolute angular coordinates, which is now known, the next step may be to determine the aperture angle γ of the cone of light 4 in the pan plane. The aperture angle γ corresponds to the difference of the absolute angular coordinates corresponding to the pan values p21 and p22.

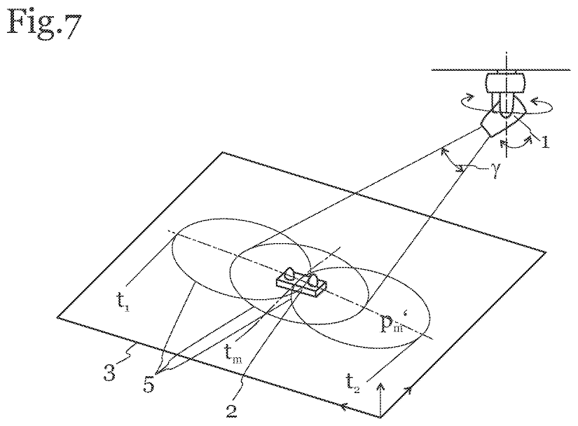

In the optional step according to FIG. 7, the spotlight is first centred on the centre pm′ in the pan axis. Then, the limits of the illuminated area t1 and t2 are determined anew by pivoting the spotlight back and forth in the tilt axis at a fixed pan value. Based on the difference of t1 and t2 the mapping rule of the tilt values to the absolute angular coordinates in the tilt plane can be calculated by comparison with the known aperture angle γ of the cone of light 4.

It is presupposed that the aperture angle γ of the cone of light 4 is identical in the pan plane and the tilt plane. In case of a non-symmetrical cone of light this may be taken into account in the calculation.

According to another embodiment of the invention, the illuminated area 5 is measured and the centre pm is determined for multiple, preferable three different, but known positions in absolute coordinates x, y, z of the light sensor 2. Preferably, this results in three tupels pt1, pt2 and pt3 of pan/tilt values.

From the tilt values and the pan values of the three light sensors together with the known respective positions x, y, z of the light sensors the position of the spotlight 1 can be determined in the absolute space by means of known methods.

Furthermore, the orientation of the spotlight 1, i. e. the direction of the cone of light emitted by the spotlight, can be determined from these values. To this end, a multi-dimensional linear equation system may be established which can be solved by a mathematical algorithm, for example a 3D solver, which is per se known.

In other embodiments of the invention, the above steps of determining a mapping rule and measuring the aperture angle and illuminated area may be performed using a single 2D camera.

1. A method for determining the position of a spotlight which is arranged above an underlying surface and creates an illuminated area on the underlying surface, wherein
a. a light sensor is arranged on the underlying surface,
i. wherein the light sensor is designed as a camera, wherein the camera has a wide-angle lens, preferably a fisheye lens, and wherein
ii. the light sensor has one to three position sensors, preferably ultra-wideband position sensors, which are designed to determine the position of the light sensor in a three-dimensional coordinate system, wherein
b. the camera creates a recording of the spotlight, and wherein
c. the position of the spotlight is at least approximately determined from the recording and the position of the light sensor.

2. The method according to claim 1, wherein the spotlight is rotatable about a pan axis by entering pan values and pivotable about a tilt axis by entering tilt values, and wherein
a. the spotlight is rotated and pivoted by entering tilt and pan values until a pan and tilt value is reached at which the camera detects the spotlight,
b. the camera creates a recording of the spotlight, and wherein
c. the position of the spotlight is at least approximately determined from the recording and the position of the light sensor.

3. The method according to claim 1, wherein
a. the light sensor is arranged at at least two different positions on the underlying surface, and
b. optionally for both positions, the spotlight is rotated and pivoted by entering tilt and pan values until a pan and tilt value is reached at which the camera detects the spotlight,
c. in both positions, the camera creates a recording of the spotlight, and wherein
d. the position of the spotlight in the coordinate system is calculated from both recordings and the positions of the light sensor.

4. The method according to claim 1, wherein
a. the light sensor is designed as a stereo camera with two separate cameras, wherein the cameras each have a wide-angle lens, preferably a fisheye lens, and
b. optionally, the spotlight is rotated and pivoted by entering tilt and pan values until a pan and tilt value is reached at which both cameras detect the spotlight, and wherein
c. the cameras each create a recording of the spotlight, and wherein
d. the position of the spotlight in the coordinate system is calculated from the different recordings of the two cameras.

5. The method according to claim 4, wherein a mapping rule of the spotlight is determined by
a. moving the illuminated area across the underlying surface by rotating and pivoting the spotlight,
b. at least one camera detecting the edges of the illuminated area, and
c. determining a mapping rule of the pan values and/or tilt values of the spotlight to the angular coordinates of the spotlight by rotating and/or pivoting the spotlight and by repeatedly detecting the illuminated area.

6. The method according to claim 5, wherein the illuminated area is moved across the underlying surface by rotating and pivoting the spotlight until at least one camera of the light sensor detects an edge of the illuminated area and, subsequently, the dimensions as well as a centre of the illuminated area are determined by varying the pan value and/or the tilt value of the spotlight.

7. The method according to claim 6, wherein the dimensions of the illuminated area are detected and that the aperture angle of the cone of light is determined from the calculated mapping rule.

8. The method according to claim 5, wherein
a. first, a mapping rule of the pan values to absolute angular coordinates and the aperture angle of the cone of light along this plane are determined by measuring the illuminated area along the plane spanned by the pan values, and
b. a mapping rule of the tilt values to absolute angular coordinates is subsequently determined by measuring the illuminated area along the plane spanned by the tilt values.

9. The method according to claim 4, wherein the mapping rule and/or the aperture angle is identified for each of the two cameras.

10. The method according to claim 1, wherein the method is applied to several spotlights in sequential order.

11. A computer-readable storage medium, comprising a computer programme for controlling the progress of a method according to claim 1.
